(19) United States
(12) Patent Application Publication
(10) Pub. No.: US 2014/0335241 A1
(43) Pub. Date: Nov. 13, 2014

(54) EDIBLE ICE CREAM CONE SKIRT

(71) Applicants: Oliver Cahners GREENWALD, Denver, CO (US); Samuel Jonathan James Nassif, Denver, CO (US)

(72) Inventors: Oliver Cahners GREENWALD, Denver, CO (US); Samuel Jonathan James Nassif, Denver, CO (US)

(21) Appl. No.: 13/895,162

(22) Filed: May 15, 2013

Related U.S. Application Data
(63) Continuation-in-part of application No. 29/454,411, filed on May 9, 2013.

(51) Int. Cl. A21D 13/00

(52) U.S. Cl. CPC A21D 13/0029
USPC 426/139

(57) ABSTRACT

A protective skirt of edible material has an inner circular opening sized for insertion of an ice cream cone so that the opening moves into firm engagement with an upper wall portion of the cone, and a lower horizontal wall of the skirt flares outwardly into one or more wall sections of generally toroidal configuration which extend above the upper opening of the body of the cone to retain any liquid or solid spillage when the ice cream is being eaten.

The present application is a Continuation-In-Part of the utility patent application Ser. No. 29/454,411 filed May 9, 2013 entitled EDIBLE FROZEN TREAT CATCHER, which is incorporated by reference herein.

### BACKGROUND AND FIELD

This invention relates to a novel and improved skirt for ice cream cones and similar hand held confectionary items which is edible, easy to install and which prevents spillage from melting of the ice cream or tipping of the cone and is of simplified one-piece construction.

Various types of drip-catching devices have been devised for ice cream cones but to our knowledge no one has devised an edible skirt of one-piece construction which can be slipped directly on to the cone to prevent accidental separation of the cone from the device when held in the hand and absorb any drippings running down the outside of the cone as well as to catch any chunks of ice cream which may spill from the cone or from a person's mouth.

### OBJECTS AND FEATURES

It is therefore an object to provide for a novel and improved edible skirt for placement on ice cream cones which acts as a receptacle for melted as well as solid ice cream.

It is another object to provide for an ice cream cone skirt of one-piece construction which can be easily positioned on a cone to facilitate gripping of the cone without breakage and enable reception of melted or overflow ice cream in the skirt as well as any broken particles of the cone.

A further object is to provide for an edible skirt of the type described which may be of one-piece construction for positioning on the conical body of a cone and having an outer toroidal wall which resists breakage and enables retention of melted or overflow ice cream along with solid portions of ice cream or of the cone itself which may break off in the course of eating the entire cone; and wherein the skirt is conformable for use with edible and non-edible ice cream holders.

In a first embodiment, a protective skirt is characterized by being of square or rectangular configuration with a lower wall extending outwardly from a central opening sized for insertion of the greater length of a cone therein until the circular edge of the opening moves into firm engagement with an upper surface portion of the cone, and the lower wall having outer vertical wall sections of convex configuration which terminate in upper horizontal wall sections of convex configuration. In a second embodiment the lower wall terminates in a continuous circular wall of convex configuration which verges into an upper horizontal wall of convex configuration. In both embodiments the vertical walls are of sufficient depth to retain liquid or solid spills as described.

The above and other advantages and features will become more readily understood from the following detailed description when taken together with the accompanying drawings in which:

### DETAILED DESCRIPTION OF DRAWINGS

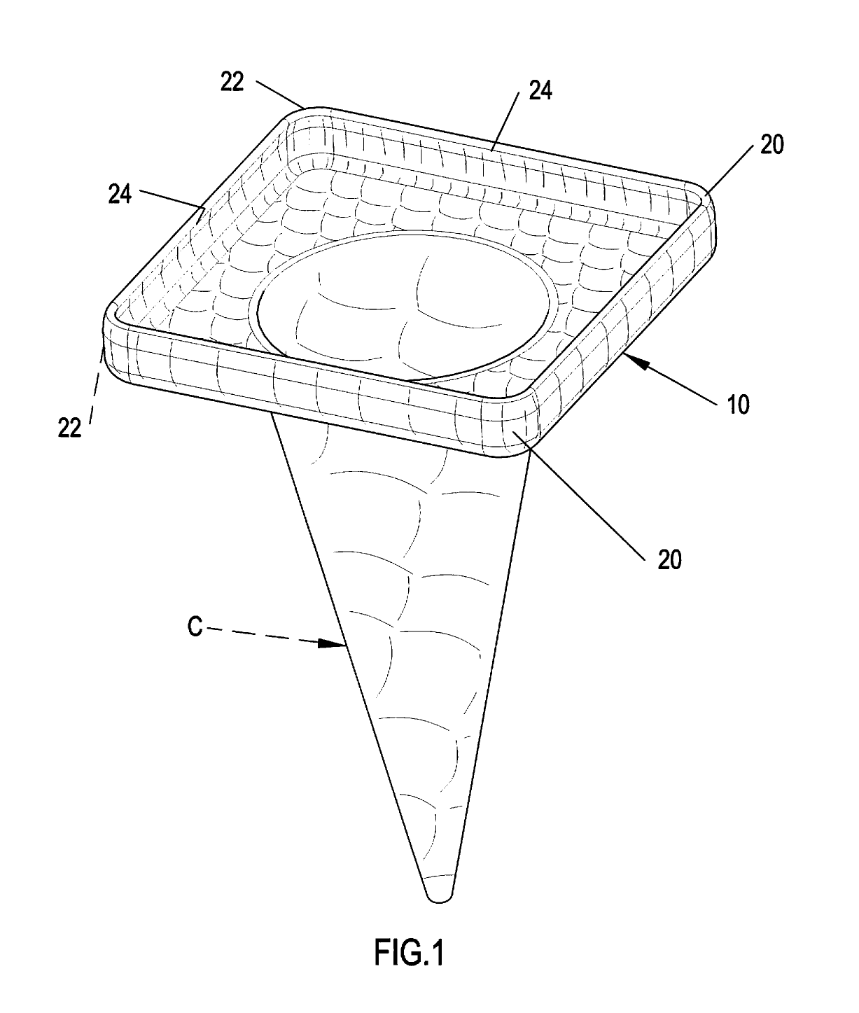

FIG. 1 is a perspective view of a first embodiment of a skirt mounted on a standard ice cream cone;

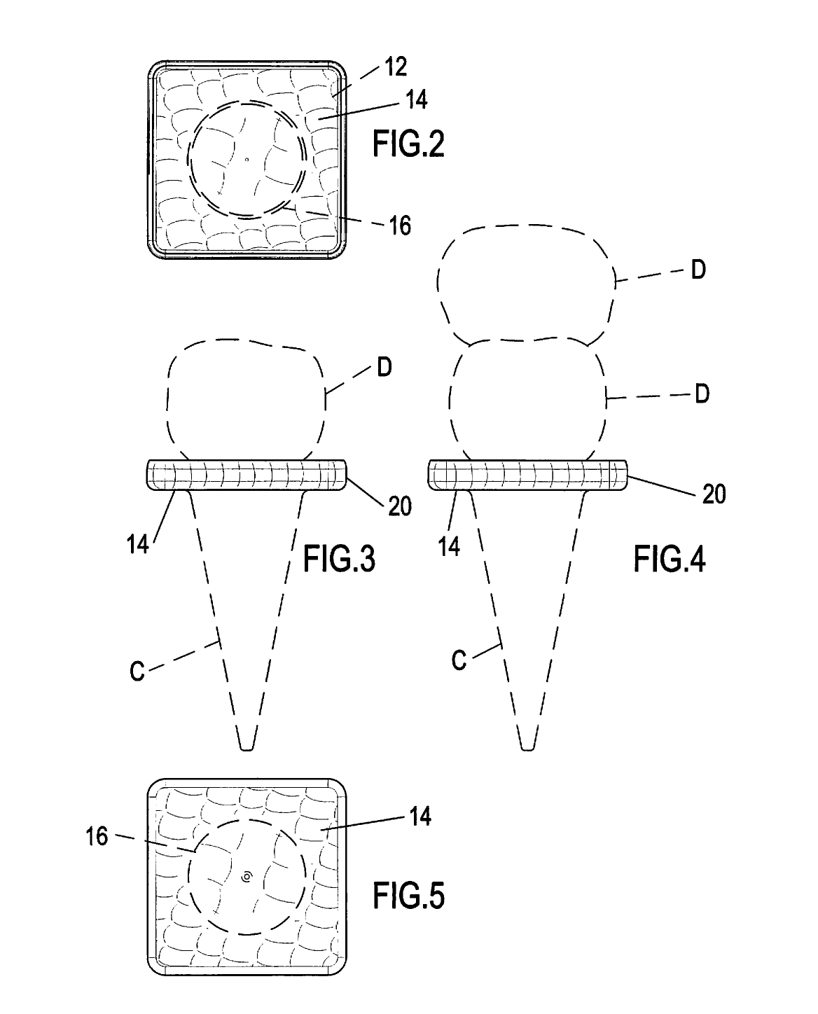

FIG. 2 is a top plan view of FIG. 1;

FIG. 3 is a front view in elevation thereof;

FIG. 4 is a side view in elevation thereof;

FIG. 5 is a bottom plan view thereof;

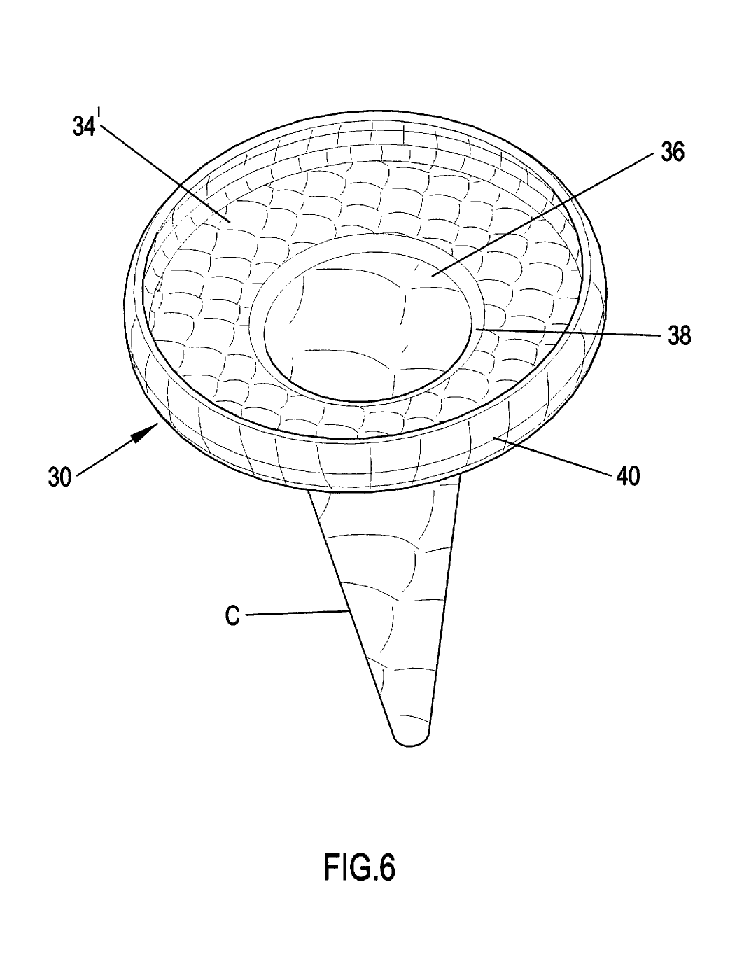

FIG. 6 is a perspective view of a second embodiment of a modified form of skirt mounted on a standard ice cream cone;

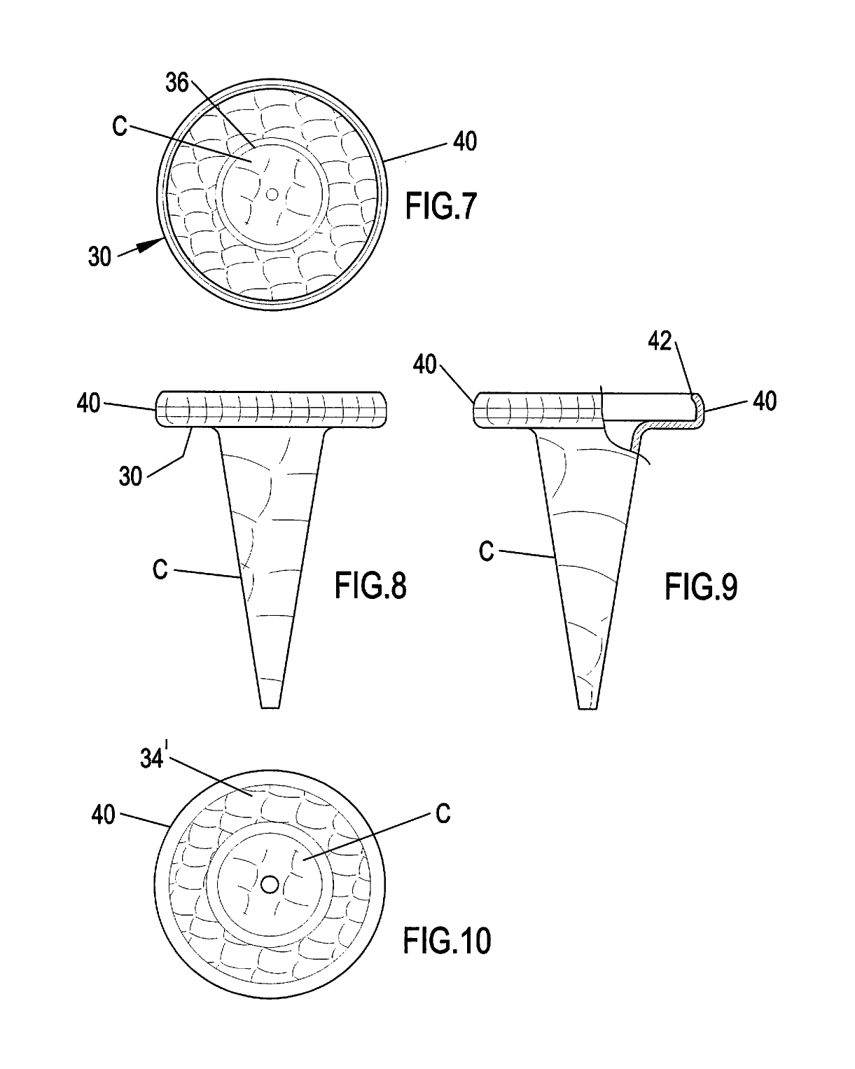

FIG. 7 is a top plan view of FIG. 6;

FIG. 8 is a front view thereof;

FIG. 9 is a side view thereof; and

FIG. 10 is a bottom plan view thereof.

### DETAILED DESCRIPTION OF FIRST EMBODIMENT

There is shown by way of illustrative example in FIGS. 1-5 a first embodiment of a protective skirt 10 for an ice cream cone represented at C, the cone being either of an edible or non-edible material and designed to support one or more dips D of ice cream as illustrated in FIGS. 3 and 4 in the upper open end 12 of the cone C. The skirt 10 is made up of a lower wall 14 flaring horizontally and outwardly from a central circular opening 16 which is sized for insertion of the greater length of the cone C until the inner circular conical edge 18 of the skirt is wedged against the upper side wall of the cone so as to leave ample space for a person's hand to grasp the lower wall portion of the cone C.

The flat horizontal wall 14 when viewed in plan as in FIGS. 3 and 5 is of square configuration but may be hexagonal or other polygonal sides, such as, rectangular. Most importantly, each of the outer edges terminates in upper generally convex wall sections 20 with adjoining vertical edges 22. In turn, the outer sections 20 verge into horizontal, inwardly extending convex wall sections 24. The vertical wall sections 2.0 are of a depth sufficient to extend above the upper edge of the cone C to catch the drippings or pieces from the dips D as well as fragments of the upper wall of the cone C. By forming a relatively deep bowl it is easier to gradually consume the spillage along with the skirt, bearing in mind that the edible composition of the bowl will permit the liquid drippings to be absorbed by the skirt. Of course if there is little or no spillage, the consumer may prefer to slide the skirt downwardly to remove from the cone C or break off portions of the bowl and discard them in order to get access to the main body and any remaining contents of the cone C.

### DETAILED DESCRIPTION OF SECOND EMBODIMENT

A modified form of skirt 30 is illustrated in FIGS. 6-10 which once again may be composed of an edible or inedible material and is comprised of a lower wall 34′ flaring outwardly in a horizontal direction from an inner circular opening 36 at its center. The opening 36 is sized to be positioned at or in close proximity to the upper edge of the cone C with a conical edge 38 conforming to the conical angle of the cone C so as to be wedged firmly against it. As best seen from FIGS. 7-10, the skirt 30 is of circular configuration and terminates in an outer circular wall 40 of generally convex configuration and which verges into an inward horizontal continuation 42 of generally convex configuration. The upper horizontal edge in both embodiments avoids sharp corners or edges while assisting in the return of any overflow or fragments in eating the ice cream and cone as well as the skirt. Further, by positioning the skirt at the upper extremity of the cone C, any spillage is returned into the cone interior after the dips D have been eaten.

Typically, the edible cones C have as their main ingredients different forms of flour, such as, bleached and enriched wheat flour along with molasses, tapioca, sugar, cinnamon, riboflavin, etc. The same ingredients may be utilized in preparing the protective skirts. In the alternative, either or both the cones C and skirts 10 and 30 may be formed of non-edible materials, such as, molded plastic or a heavy paper or cardboard material.

It is therefore to be understood that while different embodiments as well as variations thereof have been set forth and described herein other modifications and changes are possible without departing from the spirit and scope as defined by the appended claims.

We claim:

1. A protective skirt for a generally conical ice cream cone comprising a lower wall extending outwardly from a central circular opening disposed in close-fitting surrounding relation to an upper conical wall of said cone, said lower wall terminating in an outer surrounding vertical wall of convex configuration, said vertical wall extending upwardly from said lower wall and terminating in a radially inwardly directed convex rim.

2. A protective skirt according to claim 1 wherein said vertical wall and convex rim are of generally toroidal configuration.

3. A protective skirt according to claim 1 wherein said lower wall extends horizontally from said opening and terminates in an outer surrounding vertical wall of circular configuration.

4. A protective skirt according to claim 1 wherein said lower wall extends horizontally from said opening and terminates in a plurality of circumferentially extending, adjoining straight vertical wall sections in surrounding relation to said lower wall.

5. A protective skirt of one piece construction and composed of an edible material with a central opening for mounting of a generally conical ice cream cone therein, said skirt including a lower wall flaring outwardly from said opening and terminating in one or more outer walls of hollow toroidal configuration.

6. A protective skirt according to claim 5 wherein said lower wall includes an inner conical edge in surrounding relation to an upper wall of said cone with said outer wall(s) extending above said conical portion of said cone.
